(19) United States
(12) Patent Application Publication
(10) Pub. No.: US 2011/0120872 A1
(43) Pub. Date: May 26, 2011

(54) TUBE ELECTROFORMING METHOD, TUBE BY ELECTROFORMING, AND THIN WIRE MATERIAL FOR PRODUCTION OF TUBES BY ELECTROFORMING

(75) Inventors: Tokuji Oda, Fukuoka (JP); Yutaka Ichikawa, Fukuoka (JP)

(73) Assignee: LUZCOM INC., Tokyo (JP)

(21) Appl. No.: 10/593,903

(22) PCT Filed: Mar. 22, 2004
(86) PCT No.: PCT/JP2004/003895

§ 371 Date: Jul. 23, 2007

(30) Foreign Application Priority Data
Sep. 24, 2002 (JP) P2002-278121

(51) Int. Cl. C25D 1/02; B32B 1/08

(52) U.S. Cl. 205/50; 205/73; 428/34.1

(57) ABSTRACT

The invention provides a method of producing an electrocast tube having a fine inner diameter, and an electrocast tube. It also provides a thin wire material for production of an electrocast tube having a fine inner diameter. An electrocast tube producing method comprising the steps of forming an elecrtodeposit around a thin wire material (30) by electrocasting, and removing the thin wire material (30) from the electrodeposit, wherein the thin wire material (30) is removed either by heating the electrodeposit for thermal expansion or by cooling the thin wire material (30) for contraction, so as to form a clearance between the electrodeposit and the thin wire material (30), followed by gripping and pulling, or sucking the thin wire material (30) or physically pushing it away or blowing gas or liquid to push it away.

### TECHNICAL FIELD

The present invention relates to an electrically cast (referred to as “electroforming” in the present description) tube producing method, a tube by electroforming, and a thin wire material for production of tubes by electroforming, more particularly to a method of producing a tube by electroforming having a fine inner diameter, and a tube by electroforming. The present invention also relates to a thin wire material for production of a tube by electroforming having a fine inner diameter.

### BACKGROUND ART

Heretofore, in a case where an integrated circuit such as an LSI is manufactured, inspection is performed to judge whether or not a semiconductor pattern is finished as designed, and electric conduction is satisfactory. This inspection is performed using a device (referred to as the “probe device” in the present description) including a large number of contact probes, and the device is brought into contact with electrodes having contact probe pins formed thereon. The contact probe has a structure in which a spring is disposed in a very thin tube having a desired length, and the pin is disposed movably forwards or backwards in the tube.

In addition, in recent years, there has been a remarkable progress in a semiconductor manufacturing technology, and an integration degree tends to increasingly indicate a high density. With this tendency, also in the probe device which inspects the electric conduction of the electrode, so as to match with the latest integrated circuit, there is a demand for increasing of the number of the contact probes (multiple pins), reducing of a wire diameter (thin wires) and narrowing of an interval between the contact probes (reduced pitches). As to the tube for the existing contact probe, it is assumed that a tube having an outer diameter of 110 μm and an inner diameter of 88 μm is the minimum in the world (see, e.g., Non-Patent Document 1).

However, since the semiconductor manufacturing technology has increasingly progressed as described above, the contact probe also needs to be further miniaturized.

Moreover, a necessity for the tube having the fine inner diameter also enhances in a field other than a semiconductor industrial field, such as biotechnology or a medical field.

That is, there is a strong demand for development of such tube having the fine inner diameter in the whole industrial world.

The present inventor has conducted researches concerning electroforming, and has succeeded in producing a micro tube by the electroforming before. At this time, the tube by electroforming includes a hollow portion having a circular sectional shape, and has an inner diameter of 126 μm (see, e.g., Patent Document 1). Therefore, the present inventor has obtained an idea that when an electroforming technology is used, a tube having a fine inner diameter (hollow portion) for the contact probe might be produced.

Furthermore, after conducting further researches, the present inventor has succeeded in using a thin wire material having a diameter of 10 μm to 85 μm, and attaching a metal film having a minimum size of 5 μm to an outer surface of this thin wire material. Moreover, it has been found that when the above thin wire material can be removed from this metal, a tube having a fine inner diameter (hollow portion) can be made.

However, it has not been easy to remove the thin wire material from the electrodeposited (deposited) metal, because the electrodeposited metal is brought into close contact with the outer surface of the thin wire material.

Patent Document 1

Jpn. Pat. Appln. KOKAI Publication No. 2002-48947

Non-Patent Document 1

Nikkei Mechanical ON LINE, April 2001, Nikkei BP Co., internet <URL:http://dm.nikkeibp.co.jp/free/nmc/kiji/h559/t559g.html>

### OBJECTS OF THE PRESENT INVENTION

Objects of the present invention are:

(1) to provide a method of producing a tube by electroforming having a fine inner diameter, a tube by electroforming, and a thin wire material for production of the tube by electroforming;

(2) to provide a tube electroforming method in which a jig, a tool or the like can be caught by an electrodeposit material or a surrounding material in a case where a thin wire material is removed from the electrodeposit material or the surrounding material, whereby the thin wire material is easily removed;

(3) to provide a tube electroforming method in which a conductive layer plated with gold or the like is disposed on an inner surface of a tube by electroforming so that an electric conductivity is more satisfactory than that at a time when an electrodeposit material or a surrounding material only is disposed, a tube by electroforming, and a thin wire material for production of this tube by electroforming;

(4) to provide a tube electroforming method in which at least two conductive layers constituted of different materials are disposed on an inner surface of a tube by electroforming so as to improve a close contact property between the conductive layers or between the conductive layer and an electrodeposit material or a surrounding material, a tube by electroforming, and a thin wire material for production of the tube by electroforming;

(5) to provide a method of producing a tube by electroforming including a plurality of hollow portions, and a tube by electroforming;

(6) to provide a method of producing a tube by electroforming including a plurality of hollow portions so that each portion forming a periphery of each hollow portion can independently conduct electricity, and a tube by electroforming; and

(7) to provide a tube electroforming method in which a tensile force is not easily applied to a conductive layer disposed on an inner surface of a tube by electroforming in a case where a thin wire material is removed, whereby the conductive layer is easily separated from a base wire material, and a close contact property between the conductive layer and an electrodeposit material or a surrounding material is not easily impaired.

### DISCLOSURE OF THE INVENTION

Means of the present invention developed in order to achieve the above objects are as follows.

In a first aspect of the invention,
there is provided a tube electroforming method comprising the steps of: forming an electrodeposit material or a surrounding material around a thin wire material by electroforming; and removing the thin wire material from the electrodeposit material or the surrounding material,
characterized in that the thin wire material is removed either by heating the electrodeposit material or the surrounding material to thermally expand the material or by cooling the thin wire material to contract the material, so as to form a clearance between the electrodeposit material or the surrounding material and the thin wire material, followed by gripping and pulling the thin wire material, sucking the material, physically pushing away the material, or blowing a gas or a liquid to push away the material.

In a second aspect of the invention,
there is provided a tube electroforming method comprising the steps of: forming an electrodeposit material or a surrounding material around a thin wire material by electroforming; and removing the thin wire material from the electrodeposit material or the surrounding material,
characterized in that the thin wire material is removed either by submerging the material into a liquid or by applying the liquid to the material so that a place with which the thin wire material and the electrodeposit material or the surrounding material are brought into contact is formed so as to easily slip, followed by gripping and pulling the thin wire material, sucking the material, physically pushing away the material, or blowing a gas or a liquid to push away the material.

In a third aspect of the invention,
there is provided a tube electroforming method comprising the steps of: forming an electrodeposit material or a surrounding material around a thin wire material by electroforming; and removing the thin wire material from the electrodeposit material or the surrounding material,
characterized in that the thin wire material is removed by pulling the material from one end or both ends, deforming the material so as to reduce a sectional area thereof, and forming a clearance between the thin wire material and the electrodeposit material or the surrounding material, followed by gripping and pulling the thin wire material, sucking the material, physically pushing away the material, or blowing a gas or a liquid to push away the material.

In a fourth aspect of the invention,
there is provided the tube electroforming method according to the first, second or third aspect of the invention,
characterized in that an amount of an end-portion-side electrodeposit or surrounding material to be formed on the thin wire material is increased.

In a fifth aspect of the invention,
there is provided the tube electroforming method according to the third aspect of the invention,
characterized in that a deformation amount of a lateral distortion at a time when the thin wire material is pulled and extended outwards is 5% or more of the sectional area.

In a sixth aspect of the invention,
there is provided a tube electroforming method comprising the steps of: forming an electrodeposit material or a surrounding material around a thin wire material by electroforming; and removing the thin wire material from the electrodeposit material or the surrounding material,
characterized in that the thin wire material is melted with heat or a solvent and removed.

In a seventh aspect of the invention,
there is provided the tube electroforming method according to the first, second, third, fourth, fifth or sixth aspect of the invention,
characterized in that the thin wire material including a conductive layer disposed on an outer surface thereof is used, and the thin wire material is removed so that the conductive layer remains on an inner surface of a tube by electroforming.

In an eighth aspect of the invention,
there is provided the tube electroforming method according to the first, second, third, fourth, fifth or sixth aspect of the invention,
characterized in that the thin wire material is used in which at least two conductive layers constituted of different materials are formed on an outer surface of the material, the electrodeposit material or the surrounding material is brought into close contact with the outer conductive layer of the thin wire material, and the thin wire material is removed so that the inner conductive layer remains on an inner surface of the tube by electroforming.

In a ninth aspect of the invention,
there is provided the tube electroforming method according to the first, second, third, fourth, fifth, sixth, seventh or eighth aspect of the invention,
characterized in that an inner shape of a hollow portion formed by removing the thin wire material from the electrodeposit material or the surrounding material has a circular sectional shape or a polygonal sectional shape.

In a tenth aspect of the invention,
there is provided the tube electroforming method according to the first, second, third, fourth, fifth, sixth, seventh, eighth or ninth aspect of the invention,
characterized in that the tube by electroforming includes a plurality of hollow portions formed by removing the thin wire material.

In an eleventh aspect of the invention,
there is provided the tube electroforming method according to the tenth aspect of the invention,
characterized in that a partition wall member formed by disposing a conductive layer on an outer surface of an insulator is disposed between the hollow portions, whereby each portion forming a periphery of each hollow portion independently conducts electricity.

In a twelfth aspect of the invention,
there is provided a tube by electroforming produced by forming an electrodeposit material or a surrounding material around a thin wire material by electroforming, and removing the thin wire material from the electrodeposit material or the surrounding material,
characterized in that a hollow portion is formed by removing the thin wire material from the electrodeposit material or the surrounding material, an inner diameter of the hollow portion is 10 μm or more and 85 μm or less, when an inner shape of the hollow portion has a circular sectional shape, and a diameter of an inscribed circle of the hollow portion is 10 μm or more and 85 μm or less, when the inner shape of the hollow portion has a polygonal sectional shape.

In a thirteenth aspect of the invention,
there is provided the tube by electroforming according to the twelfth aspect of the invention,
characterized in that a thickness of the tube is 5 μm or more and 50 μm or less.

In a fourteenth aspect of the invention,
there is provided the tube by electroforming according to the twelfth or thirteenth aspect of the invention,
characterized in that an inner surface of the tube is provided with a conductive layer constituted of a material different from that of the electrodeposit material or the surrounding material.

In a fifteenth aspect of the invention,
there is provided the tube by electroforming according to the twelfth or thirteenth aspect of the invention,
characterized in that an inner surface of the tube is provided with a conductive layer constituted of a material different from that of the electrodeposit material or the surrounding material, and a further conductive layer constituted of a material different from that of the conductive layer is disposed between the electrodeposit material or the surrounding material and the conductive layer.

In a sixteenth aspect of the invention,
there is provided the tube by electroforming according to the twelfth, thirteenth, fourteenth or fifteenth aspect of the invention,
characterized in that there are a plurality of hollow portions formed by removing the thin wire material.

In a seventeenth aspect of the invention,
there is provided the tube by electroforming according to the sixteenth aspect of the invention,
characterized in that a partition wall member formed by disposing a conductive layer on an outer surface of an insulator is disposed between the hollow portions, whereby each portion forming a periphery of each hollow portion independently conducts electricity.

In an eighteenth aspect of the invention,
there is provided the tube by electroforming according to the seventeenth aspect of the invention,
characterized in that the conductive layer disposed on the outer surface of the partition wall member forms a part of the hollow portion.

In a nineteenth aspect of the invention,
there is provided the tube by electroforming according to the seventeenth or eighteenth aspect of the invention,
characterized in that a portion of the partition wall member disposed between the hollow portions disposed adjacent to each other has a thickness of 5 μm or more and 50 μm or less.

In a twentieth aspect of the invention,
there is provided a thin wire material for production of a tube by electroforming produced by forming an electrodeposit material or a surrounding material around the thin wire material by electroforming, and removing the thin wire material from the electrodeposit material or the surrounding material,
characterized in that an outer diameter of the thin wire material is 10 μm or more and 85 μm or less, when an outer shape of the thin wire material has a circular sectional shape, a diameter of an inscribed circle is 10 μm or more and 85 μm or less, when the outer shape of the thin wire material has a polygonal sectional shape, and a deformation amount of a lateral distortion at a time when the thin wire material is pulled and extended outwards is 5% or more of a sectional area.

In a twenty-first aspect of the invention,
there is provided the thin wire material for the production of the tube by electroforming according to the twentieth aspect of the invention,
characterized in that an outer surface of the material is provided with a conductive layer constituted of a material different from that of the electrodeposit material or the surrounding material.

In a twenty-second aspect of the invention,
there is provided the thin wire material for the production of the tube by electroforming according to the twentieth aspect of the invention,
characterized in that an outer surface of the material is provided with a conductive layer constituted of a material different from that of the electrodeposit material or the surrounding material, and a further conductive layer constituted of a material different from that of the conductive layer is disposed between a base member of the thin wire material and the conductive layer.

In a twenty-third aspect of the invention,
there is provided the thin wire material for the production of the tube by electroforming according to the twentieth, twenty-first or twenty-second aspect of the invention,
characterized in that there are opposite end portions on which any conductive layer is not disposed.

In a twenty-fourth aspect of the invention,
there is provided the thin wire material for the production of the tube by electroforming according to the twentieth, twenty-first, twenty-second or twenty-third aspect of the invention,
characterized in that an outer shape of the material is formed into a circular sectional shape or a polygonal sectional shape.

As to the thin wire material, there can be used a material such as a metal wire material entirely formed of a conductive material, or a material formed by disposing the conductive layer (e.g., a metal such as plating, carbon or the like) around the conductive material. Alternatively, there can be used a material formed by using a thin wire material formed of an insulating material, such as a synthetic resin wire material, and disposing a conductive layer (e.g., a metal such as electroless plating, carbon or the like) around this material.

Furthermore, in a case where a separate conductor is disposed in the vicinity of the thin wire material, and a metal is electrodeposited (deposited) on the conductor, in addition to the above thin wire material, there can further be used a material entirely formed of an insulating material (any conductive material is not disposed), such as the synthetic resin wire material.

There is not any special restriction on a material of a place where the metal is electrodeposited by the electroforming as long as the material has conductivity, but it is preferable to use a material having a satisfactory electric conductivity in order to easily electrodeposit the metal. It is possible to use, for example, iron, stainless steel, copper, gold, silver, brass, nickel, aluminum, carbon or the like.

Moreover, as the thin wire material or an insulating material constituting an insulator of the partition wall member, there can be used a nonconductor (insulating material) through which electricity does not remarkably easily flow or a semiconductor which changes to a conductor or a nonconductor in accordance with a temperature or the like. As to the insulating material, it is possible to use a material made of, for example, a thermosetting resin, a thermoplastic resin, an engineering plastic, a chemical fiber (synthetic fiber, semi-synthetic fiber, regenerated fiber or inorganic fiber) or the like. Examples of the material include: a phenol resin; urea resin; melamine resin; diallyl phthalate rein; unsaturated polyester resin; silicone resin; epoxy resin; polyethylene; crosslinked polyethylene; chlorinated polyethylene; ethylene/vinyl acetate copolymer; polypropylene; polyisobutylene; polyvinylchloride; polyvinylidene chloride; polyvinyl alcohol; polyvinyl acetal; acrylic resin; polyvinyl acetate; polyacrylonitrile; modacryl; polystyrene; styrene/acrylonitrile copolymer; acrylonitrile/butadiene/styrene ternary copolymer; acetate; triacetate; fluorine resin; polytetrafluoroethylene; polybutylene terephthalate; polyarylate; polyacetal; polycarbonate; polyphenylene sulfide; polysulfone; total aromatic polyimide; polyamide imide; polyether imide; polyether ether ketone; polybenzimidazole; polyester; polyethylene terephthalate; polyamide; nylon; aramid; polyurethane; spandex; polyalkylene paraoxybenzoate; benzoate; polyfluoroethylene; promix; rayon; cupra; and glass fiber.

Furthermore, as the insulating material, it is possible to use a so-called filament yarn which is not intertwisted or spun, or a spun yarn.

The term “circular sectional shape” indicated by the inner shape of the tube by electroforming or the outer shape of the thin wire material does not strictly mean that the sectional shape is a circular shape, and is used as an idea including a substantially circular shape or an elliptic shape.

The term “polygonal sectional shape” indicated by the inner shape of the tube by electroforming or the outer shape of the thin wire material does not strictly mean that the sectional shape is a polygonal shape, and is used as an idea including a substantially polygonal shape. There is not any special restriction on the polygonal shape, and typical examples of the polygonal shape include a substantially triangular shape, a substantially quadrangular shape (including a rectangular shape, a square shape, a rhombic shape and a parallelogram shape), a substantially pentagonal shape and a hexagonal shape.

Examples of the solvent which dissolves and removes the thin wire material include an alkaline solution and an acidic solution.

There is not special restriction on an application of the tube by electroforming, but examples of the application include a tube (casing which contains a spring) for a contact probe.

The “portion forming the periphery of the hollow portion” indicates the electrodeposit material or the surrounding material formed by the electroforming in some case, or a conductive layer (including the conductive layer of the partition wall member) having the material different from that of the electrodeposit material or the surrounding material and disposed on the inner surface of the hollow portion in other cases.

(Function)

According to the present invention, a thin wire material can be removed from an electrodeposit material or a surrounding material formed by electroforming. The thin wire material is removed using any of methods of: (1) heating and thermally expanding the electrodeposit material or the surrounding material, or cooling and contracting the thin wire material to thereby form a clearance between the electrodeposit material or the surrounding material and the thin wire material; (2) submerging the material into a liquid or applying the liquid to the material, whereby a place with which the thin wire material and the electrodeposit material or the surrounding material are brought into contact is formed so as to easily slip; or (3) pulling the material from one end or both ends, deforming the material so as to reduce a sectional area thereof, and forming the clearance between the thin wire material and the electrodeposit material or the surrounding material, followed by gripping and pulling the material, sucking the material, physically pushing away the material, or blowing a gas or a liquid to push away the material. The material can also be removed by (4) melting the material with heat or a solvent.

When such method is used in removing the thin wire material, and, for example, a thin wire material having a diameter of 10 μm to 85 μm is used, the thin wire material can be removed even from the electrodeposit material or the surrounding material formed on the outer surface of this thin wire material so as to have a thickness of 5 μm or more and 50 μm or less. Therefore, when this thin wire material removing method is used, it is possible to produce, for example, a tube by electroforming usable as a tube for a contact probe or the like and having a fine inner diameter.

According to a method of increasing an amount of an end-portion-side electrodeposit or surrounding material to be formed on the thin wire material to produce the tube by electroforming, for example, in a case where the thin wire material is extracted or pushed away and removed from the electrodeposit material or the surrounding material, a jig, a tool or the like can be caught by an end surface of the portion in which the amount of the electrodeposit material or the surrounding material is increased. Therefore, in this case, the thin wire material can be removed in a state in which the electrodeposit material or the surrounding material is fixed, and therefore the thin wire material is easily removed.

According to a tube electroforming method in which a deformation amount of a lateral distortion is set to 5% or more of the sectional area at a time when the thin wire material is pulled and extended outwards, since a clearance sufficient for removing the thin wire material can be formed between the thin wire material and the electrodeposit material or the surrounding material, there is a high possibility that the thin wire material can be removed from the electrodeposit material or the surrounding material without any trouble. If the deformation amount of the lateral distortion is only less than 5% of the sectional area, the clearance is not sufficient. Therefore, the trouble sometimes occurs during the removing.

According to a tube electroforming method in which the thin wire material having a conductive layer disposed on the outer surface thereof is used, and the thin wire material is removed so that the conductive layer remains on the inner surface of the tube by electroforming, it is possible to produce the tube by electroforming having gold plating or the like disposed on the inner surface thereof. In accordance with, for example, a material of the conductive layer disposed on the inner surface of the tube, such tube by electroforming can have an electric conductivity which is more satisfactory than that of a case where the electrodeposit material or the surrounding material only is disposed. Therefore, in this case, the tube is usable as a component suitable for conducting electricity.

It is to be noted that even as to the tube by electroforming having the inner surface provided with a conductive layer constituted of a material different from that of the electrodeposit material or the surrounding material, or the thin wire material having the outer surface provided with the conductive layer constituted of the material different from that of the electrodeposit material or the surrounding material, it is similarly possible to form the tube by electroforming having an electric conductivity which is more satisfactory than that of the case where the electrodeposit material or the surrounding material only is disposed.

According to a tube electroforming method in which there is used a thin wire material having the outer surface provided with at least two or more conductive layers constituted of different materials, for example, the outer conductive layer is made of copper, the inner conductive layer brought into contact with copper is made of gold, and nickel is formed as the electrodeposit material or the surrounding material by the electroforming. In this case, nickel has a satisfactory close contact property with respect to copper rather than gold, copper also has a satisfactory close contact property with respect to gold, and it is therefore possible to produce the tube by electroforming having a satisfactory close contact property.

It is to be noted that as to a tube by electroforming in which the conductive layer constituted of the material different from that of the electrodeposit material or the surrounding material is disposed on the inner surface of the tube and in which a further conductive layer constituted of the material different from that of the conductive layer is disposed between the electrodeposit material or the surrounding material and the above conductive layer, or as to a thin wire material in which the conductive layer constituted of the material different from that of the electrodeposit material or the surrounding material is disposed on the outer surface of the material and in which the further conductive layer constituted of the material different from that of the conductive layer is disposed between a thin wire material base member and the above conductive layer, it is similarly possible to form the tube by electroforming having the satisfactory close contact property between the electrodeposit material or the surrounding material and the conductive layer.

A component including a plurality of hollow portions formed by removing the thin wire material may replace, for example, a component produced by arranging a plurality of tubes each having only one hollow portion, and may be used. According to the tube by electroforming, it is possible to eliminate an operation of arranging the individual tubes. An interval between the hollow portions does not deviate because the portions are fixed with the electrodeposit material or the surrounding material.

In a case where a partition wall member formed by disposing the conductive layer on the outer surface of an insulator is disposed between the hollow portions, and each portion forming the periphery of each hollow portion can independently conduct electricity, each hollow portion can independently conduct electricity.

As to a thin wire material having, on opposite ends, portions on which any conductive layer is not disposed, in a case where the portion on which any conductive layer is not disposed is pulled outwards, a tensile force is not directly or easily applied to the conductive layer, the conductive layer is easily separated from a base wire material, and the close contact property between the conductive layer and the electrodeposit material or the surrounding material is not easily impaired.

### BRIEF DESCRIPTION OF THE DRAWINGS

FIG. 1 is a sectional explanatory view showing one example of an electroforming device for producing a tube by electroforming of the present invention;

FIG. 2 is an explanatory view showing a state in which an enlarged diameter portion is formed on one end of an electrodeposit material;

FIG. 3 is a sectional explanatory view showing a state in which an electrodeposit material is formed around a thin wire material having a substantially quadrangular sectional shape;

FIG. 4 is a sectional explanatory view showing a state in which an electrodeposit material is formed around a thin wire material having a conductive layer disposed on an outer peripheral surface thereof;

FIG. 5 is a sectional explanatory view showing a state in which an electrodeposit material is formed around a thin wire material having an outer peripheral surface provided with two conductive layers constituted of different materials;

FIG. 6 is an explanatory view showing a state in which an electrodeposit material is formed around a thin wire material having, on opposite ends, portions where any conductive layer is not disposed;

FIG. 7 is a sectional explanatory view showing another example of the electroforming device for producing the tube by electroforming of the present invention;

FIG. 8 is an exploded perspective explanatory view showing a jig for the production to be used in the electroforming device shown in FIG. 7; and

FIG. 9 is an enlarged sectional explanatory view showing a tube by electroforming produced using the jig for production shown in FIG. 8.

### BEST MODE FOR CARRYING OUT THE INVENTION

An embodiment of the present invention will be described in more detail with reference to the drawings.

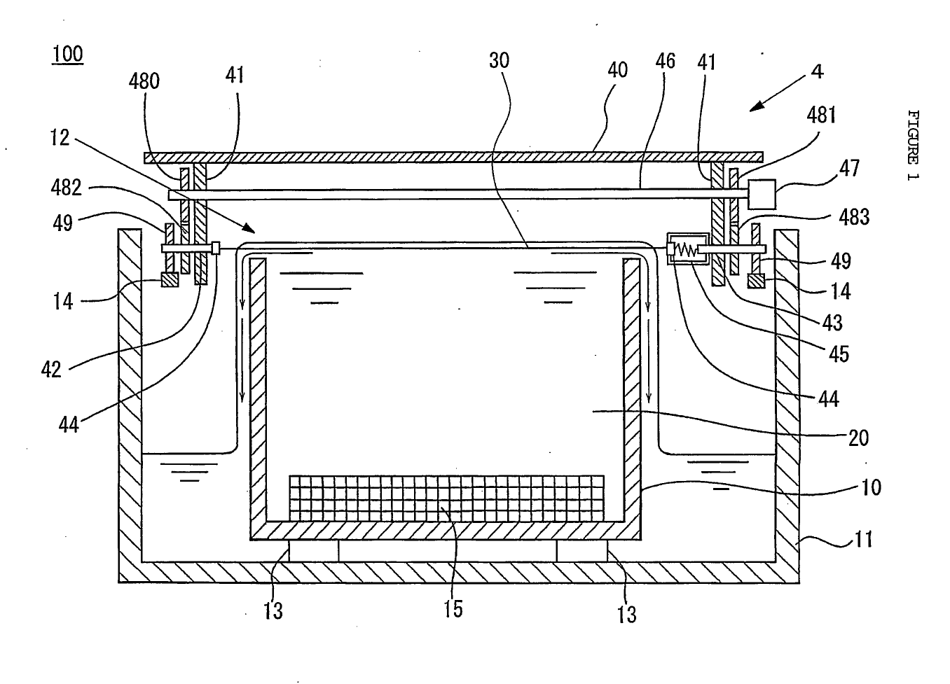

FIG. 1 is a sectional explanatory view showing one example of an electroforming device for producing a tube by electroforming of the present invention.

First, there will be described the electroforming device which produces the tube by electroforming.

An electroforming device 100 includes an electroforming tank 10 and an outer tank 11 which contains therein this electroforming tank 10. The electroforming tank 10 and the outer tank 11 have opened upper portions, and an electrolyte liquid (electroforming liquid) 20 is supplied into the electroforming tank 10 during operation. In this manner, the electrolyte liquid 20 overflows from the upper portion of the electrolyte liquid 20, and flows into the outer tank 11. In the present embodiment, as the electrolyte liquid 20, there is used, for example, a nickel sulfamate liquid to which a brightener or a bit preventive agent is applied.

The electrolyte liquid 20 which overflows from the electroforming tank 10 to flow into the outer tank 11 is filtered by a filtering device (not shown), and supplied into the electroforming tank 10 again. That is, the electrolyte liquid 20 constantly circulates between the electroforming tank 10 and the outer tank 11 during the operation. It is to be noted that as supplying means for supplying the electrolyte liquid 20 to the electroforming tank 10, known means is usable (not shown).

In the present embodiment, a portion of the electrolyte liquid 20 which overflows from the upper portion of the electroforming tank 10 is referred to as an overflow portion 12 for convenience. In the electroforming device 100, the electroforming is performed in this overflow portion 12. An electroforming procedure will be described later.

A horizontal adjuster unit 13 is disposed under the electroforming tank 10. This horizontal adjuster unit 13 substantially horizontally holds the electroforming tank 10, whereby the substantially horizontal overflow portion 12 is formed in the whole upper portion of the electroforming tank 10, and the electrolyte liquid 20 can uniformly be distributed into each place of the overflow portion 12.

Reference numeral 4 denotes a holding jig to hold a thin wire material 30 which is a mold member (mother material) for electroforming. The holding jig 4 includes a horizontal member 40 and a pair of hanging members 41, 41 vertically disposed downwards from opposite ends of this horizontal member 40. The holding jig 4 is disposed so that the hanging members 41, 41 are positioned on opposite outer sides of the electroforming tank 10.

From the hanging members 41, 41, rod-like wire material fixing members 42, 43 having desired lengths are substantially extended in a horizontal direction, respectively. The wire material fixing members 42, 43 are rotatably disposed on the hanging members 41, 41. An electrode 44 is disposed on an end portion of one wire material fixing member 42 on the side of the electroforming tank 10. An end portion of the other wire material fixing member 43 on the electroforming tank 10 side is provided with a tension unit 45 which pulls the thin wire material 30, and an electrode 44. One end and the other end of the thin wire material 30 are fixed to the wire material fixing members 42, 43, respectively, and the material is disposed in a state in which tension is given by the tension unit 45.

A rotary shaft 46 is rotatably disposed between the hanging members 41 and 41. Reference numeral 47 denotes a driving motor which drives the rotary shaft 46. The rotary shaft 46 extends through the hanging members 41, 41, and gears 480, 481 are fixed to opposite ends of the shaft.

The above wire material fixing members 42, 43 extend through the hanging members 41, 41. A gear 482 is fixed to the wire material fixing member 42 which extends through the hanging member 41. Similarly, a gear 483 is fixed to the wire material fixing member 43 which extends through the hanging member 41. In this manner, the gear 480 engages with the gear 482, and the gear 481 engages with the gear 483. Therefore, when the driving motor 47 is operated to rotate the gears 480, 481 together with the rotary shaft 46, the gears 482, 483 and the wire material fixing members 42, 43 rotate, and further the thin wire material 30 can rotate. There is not any special restriction on a rotation speed of the thin wire material 30. For example, the speed is controlled to 15 r.p.m. or less.

Outer end portions of the wire material fixing members 42, 43 are provided with electrode contact members 49, 49 each having a conductivity. When the holding jig 4 is disposed above the electroforming tank 10, the electrode contact members 49, 49 come into contact with electrode portions 14, 14 disposed between the electroforming tank 10 and the outer tank 11. The electrode portions 14, 14 are connected to a minus pole of a power source. Therefore, the electrode contact members 49, 49 are electrically connected to the power source minus pole in a state in which the members are brought into contact with the electrode portions 14, 14.

Reference numeral 15 denotes an electrode portion electrically connected to a plus pole of the power source. The electrode portion 15 is disposed in a bottom portion of the electroforming tank 10. As the electrode portion 15, there is usable a constitution or the like in which electroforming metal pellets (e.g., nickel pellets) are stored in a meshed or holed case made of, for example, titanium steel.

There will be described a tube electroforming method in which the electroforming device 100 is used.

First, one end portion and the other end portion of the thin wire material 30 are fixed to the wire material fixing members 42, 43, respectively, and the tension is given to the thin wire material 30 between the wire material fixing members 42 and 43. At this time, the electrolyte liquid 20 is supplied to the electroforming tank 10, overflows from the upper portion of the electroforming tank 10 (to form the overflow portion 12), and flows into the outer tank 11. The electroforming tank 10 is set to be substantially horizontal by the horizontal adjuster unit 13, and the overflow portion 12 is adjusted so that the electrolyte liquid 20 is uniformly distributed to each place.

In the present embodiment, as the thin wire material 30, there was used a material which was made of stainless steel having a substantially circular sectional shape with a diameter of 50 μm and in which a deformation amount of a lateral distortion at a time when a tensile force of approximately 1500 N/mm2 was applied to pull the material outwards was 10% of a sectional area.

Next, the driving motor 47 is operated to rotate the gears 480, 481 together with the rotary shaft 46. Accordingly, the gears 482, 483 and the wire material fixing members 42, 43 rotate, and the thin wire material 30 rotates.

The electrode contact members 49, 49 are brought into contact with the electrode portions 14, 14, the hanging members 41, 41 are positioned on the opposite outer sides of the electroforming tank 10, and the only thin wire material 30 is submerged into the overflow portion 12. When the electrode contact members 49, 49 come into contact with the electrode portions 14, 14, the electrode portion 15 is electrically connected to the plus pole of the power source. Therefore, the thin wire material 30 is electrically connected to the minus pole of the power source to start the electroforming. In this manner, a metal (nickel deposited by the electrolyte liquid 20 described in the present embodiment) is electrodeposited (deposited) around the thin wire material 30. The metal electrodeposited around the thin wire material 30 is an electrodeposit material (or a surrounding material).

The thin wire material 30 is submerged into the overflow portion 12 for a predetermined time, and the electroforming is performed until an outer diameter of the electrodeposited metal reaches approximately 70 μm over the whole length. When a target outer diameter is reached, the thin wire material 30 is taken out of the overflow portion 12 to stop the electroforming. An electrodeposit amount (deposit amount) of the metal, that is, a thickness of the metal to be electrodeposited on the thin wire material can be controlled beforehand in accordance with a current, a voltage, an electroforming time or the like.

In the electroforming device 100, the overflow portion 12 is adjusted so that the electrolyte liquid 20 is uniformly distributed to each place. Additionally, the thin wire material 30 is rotated. Therefore, even if a non-uniform place is generated in a current density of the electrolyte liquid 20, a fluctuation is not easily generated in an electrodeposit state (deposit state) of the metal in the thin wire material 30. Consequently, the metal is electrodeposited around the thin wire material 30 so as to have a substantially uniform thickness over the whole length. In consequence, when the thin wire material 30 is only removed, it is possible to produce the tube by electroforming with a high precision.

Moreover, the electroforming device 100 performs the electroforming in the overflow portion 12, and the electrolyte liquid 20 which has overflowed returns to the electroforming tank 10 to circulate again. That is, during the electroforming, the overflow portion 12 is preferably formed. Therefore, it is possible to perform the electroforming even with a small amount of electrolyte liquid 20.

In the electroforming device 100, since the wire material fixing members 42, 43 to fix the thin wire material 30 are arranged outwardly from the overflow portion 12, the wire material fixing members 42, 43 are not submerged into the electrolyte liquid 20. Therefore, the wire material fixing members 42, 43 or the like do not react with the electrolyte liquid 20, and any impurity is not generated. Any electrolyte liquid 20 is not attached to or carried by the wire material fixing members 42, 43 or the like, and the electrolyte liquid 20 in the electroforming tank 10 is not wasted.

Moreover, the thin wire material 30 around which the metal has been electrodeposited is detached from the wire material fixing members 42, 43, and finally the thin wire material 30 is removed from the finally formed electrodeposit material (surrounding material).

The electrodeposit material is brought into close contact with the outer surface of the thin wire material 30. Therefore, when the thin wire material 30 is simply gripped and pulled, sucked, physically pushed away, or pushed away with a blown gas or liquid, it is difficult to remove the material. Therefore, the thin wire material 30 is removed using any of the following methods (1) to (4).

(1) The electrodeposit material is heated and thermally expanded, or the thin wire material 30 is cooled and contracted, and a clearance is formed between the electrodeposit material and the thin wire material 30. The thin wire material 30 is removed using any of methods of gripping and pulling the thin wire material, sucking the material, physically pushing away the material, and blowing the gas or the liquid to push away the material.

(2) The thin wire material 30 is submerged into a liquid in which a detergent is dissolved, or this liquid is applied to the material, whereby a place where the material is brought into contact with the electrodeposit material is set to easily slip. Moreover, the thin wire material 30 is removed using any of the methods of gripping and pulling the thin wire material, sucking the material, physically pushing away the material, and blowing the gas or the liquid to push away the material.

(3) The thin wire material 30 is pulled from one end or both ends thereof, and deformed so as to reduce a sectional area thereof. Moreover, the clearance is formed between the electrodeposit material and the thin wire material 30, and the thin wire material 30 is removed using any of the methods of gripping and pulling the thin wire material, sucking the material, physically pushing away the material, and blowing the gas or the liquid to push away the material.

(4) The thin wire material 30 is melted by heat, or melted by a solvent such as an alkaline solution or an acidic solution and removed.

When the thin wire material 30 is removed in this manner, the tube by electroforming having a fine inner diameter (hollow portion) is formed the remaining electrodeposit material. The tube by electroforming is usable as the tube for the contact probe or the like.

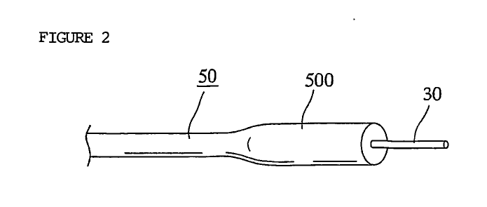

In the present embodiment, the thin wire material is removed from the electrodeposit material having a substantially uniform thickness over the whole length, but this is not restrictive. For example, as shown in FIG. 2, an enlarged diameter portion 500 having a large outer diameter is formed on one end of an electrodeposit material 50, and the thin wire material 30 is removed using any of the methods of pulling the thin wire material, sucking the material, physically pushing away the material, and blowing the gas or the liquid to push away the material. Since the enlarged diameter portion 500 is formed in this manner, the jig or the tool can be caught by an end surface of the enlarged diameter portion 500, in a case where the material is extracted or pushed away. Therefore, in this case, the thin wire material 30 can be removed in a state in which the electrodeposit material is fixed, and therefore the thin wire material is easily removed. It is to be noted that an operation of increasing an electrodeposit amount of a part in this manner is sometimes performed, after the electrodeposit material is transferred to another electroforming device.

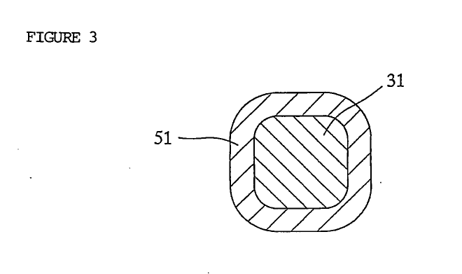

Moreover, in the above embodiment, as the thin wire material 30, there was used a material having a substantially circular sectional shape with a diameter of 50 μm. However, a thickness or a sectional shape of the thin wire material is not limited to this. For example, as shown in FIG. 3, there may be used a thin wire material 31 (including a material having a substantially polygonal shape in which corner portions are rounded) having a polygonal sectional shape such as a quadrangular shape. Reference numeral 51 denotes an electrodeposit material.

It is seen from an experiment conducted by the present inventor that it is possible to use the above thin wire material having an outer diameter of 10 μm or more and 85 μm or less, when the sectional shape has a substantially circular shape, or having an inscribed circle diameter of 10 μm or more and 85 μm or less, when the outer shape has a polygonal sectional shape, in a case where the tube by electroforming having a fine inner diameter is produced.

Moreover, as the thin wire material 30 described in the present embodiment, there was used a material in which a deformation amount of a lateral distortion was 10% of a sectional area at a time when a tensile force of 1500 N/mm² was applied to pull the material outwards. However, there is not any special restriction on the deformation amount of the lateral distortion of the thin wire material. According to the experiment conducted by the present inventor, the deformation amount may be at least 5% or more of the sectional area.

In the present embodiment, the metal is electrodeposited into a thickness of approximately 10 μm around the thin wire material 30 having a substantially circular shape with a diameter of 50 μm, and the tube by electroforming is formed so that an outer diameter is approximately 70 μm as a whole, but there is not any special restriction on the thickness of the metal to be electrodeposited. According to the experiment conducted by the present inventor, it is seen that in a case where the metal can be electrodeposited around the thin wire material 30 so as to have a thickness of at least approximately 5 μm, even after the thin wire material 30 is removed, the tube by electroforming can be formed.

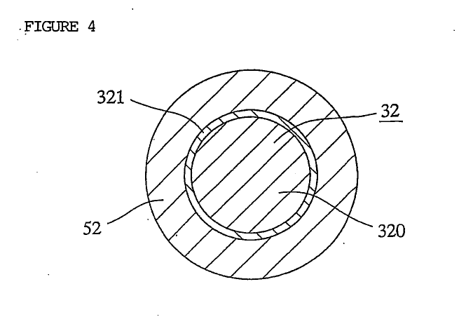

In the present embodiment, the thin wire material 30 made of stainless steel is used, and the metal is directly electrodeposited around this thin wire material 30. However, there is not any special restriction on the thin wire material usable in the electroforming device 100 as long as the material has the conductivity. For example, a material may be used in which a core portion is made of a metal, a synthetic resin or the like, and a conductive layer (plating (metal layer (film)), carbon or the like) is disposed on the outer surface of the core portion. When such thin wire material is used, for example, as shown in FIG. 4, in a case where an electrodeposit material 52 is formed on a thin wire material 32 having gold plating 321 disposed on an outer peripheral surface of the material, the gold plating 321 is left on an inner peripheral surface of the electrodeposit material 52, and a base wire material 320 only can be removed. In this case, it is possible to form the tube by electroforming having the gold plating 321 disposed on the inner peripheral surface of the tube.

In the tube by electroforming having the gold plating 321 disposed on the inner peripheral surface of the tube, the electric conductivity can be set to be more satisfactory than that in a case where any gold plating 321 is not disposed. Therefore, the tube is usable as a tube for the contact probe or the like, which is a component suitable for conducting electricity.

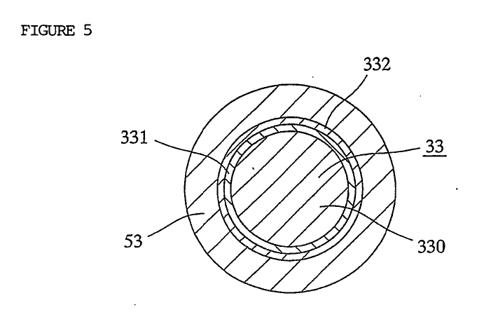

Furthermore, as the thin wire material, for example, a material is usable in which on an outer periphery of the above conductive layer formed by the plating or the like, another conductive layer constituted of a material different from that of the above layer is further disposed. For example, in a case where the metal to be electrodeposited by the electroforming is nickel, and an electrodeposit material 53 is formed around a thin wire material 33 having copper plating 332 disposed on an outer periphery of gold plating 331 (see FIG. 5), nickel has a satisfactory close contact property with respect to copper rather than gold, and copper also has a satisfactory close contact property with respect to gold. Therefore, when a base wire material 330 only is removed, it is possible to form a tube by electroforming in which nickel, copper and gold are bonded with the satisfactory close contact property. The gold plating 331 is exposed on the inner peripheral surface of the tube by electroforming.

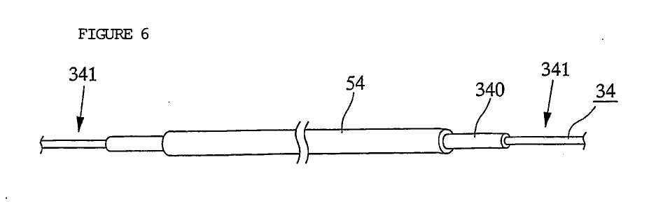

In a case where the thin wire material having the conductive layer (e.g., the gold plating) disposed on an outer peripheral portion of the material is deformed so as to reduce the sectional area of the material, and removed from the deposited metal, it is preferable that, as shown in FIG. 6, on opposite ends of a thin wire material 34, there are formed portions (masking portions 341, 341) in which any conductive layer (e.g., the gold plating 340) is not disposed, and the portion which is not provided with the conductive layer is pulled. In this case, any tensile force is not easily or directly applied to the conductive layer, the conductive layer is easily separated from the base wire material, and the close contact property between the conductive layer and an electrodeposit material 54 is not easily impaired.

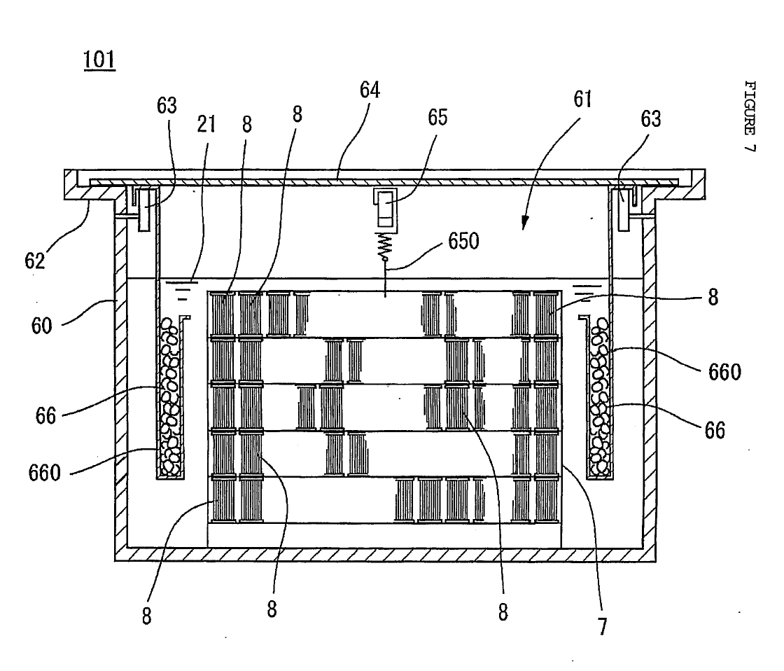

FIG. 7 is a sectional explanatory view showing another example of the electroforming device for producing the tube by electroforming of the present invention;

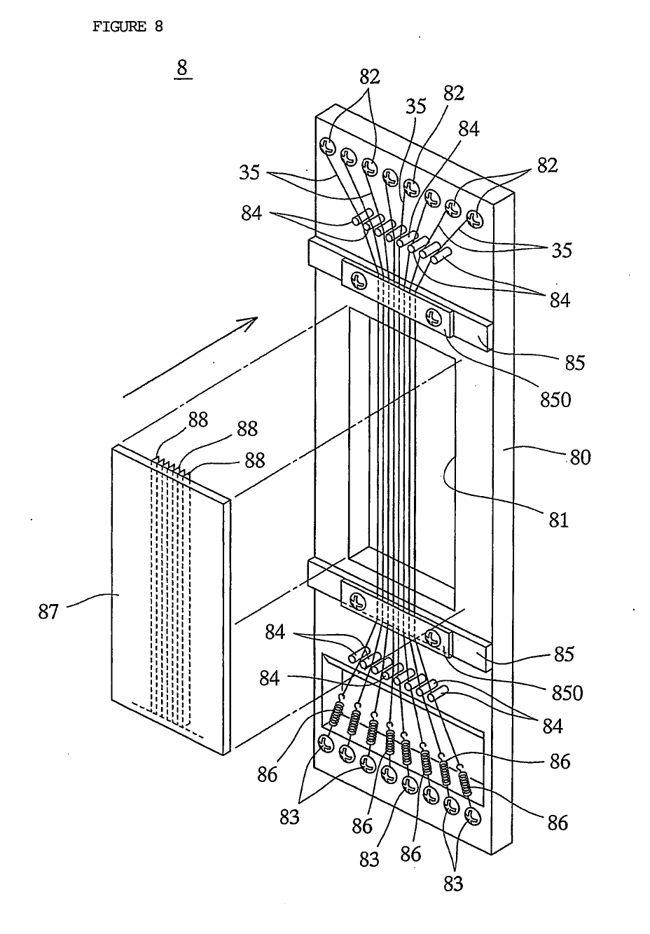

FIG. 8 is an exploded perspective explanatory view showing a jig for the production to be used in the electroforming device shown in FIG. 7; and

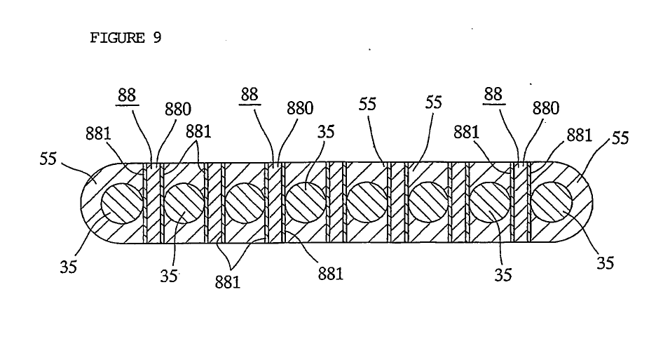

FIG. 9 is an enlarged sectional explanatory view showing a tube by electroforming produced using the jig for the production shown in FIG. 8.

An electroforming device 101 of such a type that a thin wire material is disposed in a state in which tension is given to the material in a vertical direction (perpendicular direction in FIG. 7).

The electroforming device 101 includes an electroforming tank 60. The electroforming tank 60 is formed into a box shape having therein a tank portion 61 and having an upper portion opened. On an upper edge of the electroforming tank 60, a lid laying portion 62 expanding outwards is disposed over the whole periphery, and the lid laying portion 62 is covered with a lid member 64 so as to close an opening of the electroforming tank 60.

Hook portions 63 are disposed in an upper portion of the tank portion 61. To the hook portions 63, anode portions 66 are attached which are electrically connected to a plus pole of a power source. To the anode portions 66, housing members 660 are attached, and the housing members 660 are packed with a large number of nickel balls. Reference numeral 65 denotes a cathode portion electrically connected to the housing members 660. In the cathode portion 65, a cathode wire 650 to be connected to producing jigs 8 described later is disposed to hang downwards.

In the present embodiment, the housing member 660 is packed with the nickel balls, but members with which the housing member 660 is to be packed are not limited to them, and they are selected in accordance with a type of the metal to be deposited. There may be used, for example, nickel, iron, copper, cobalt or the like. There is not any special restriction on a shape or a structure.

A jig fixing frame member 7 is contained in the tank portion 61. In the jig fixing frame member 7, the producing jigs 8 are stacked in five stages.

The tank portion 61 of the electroforming tank 60 is filled with an electrolyte liquid 21. The electrolyte liquid 21 is disposed so that the anode portions 66 and the jig fixing frame member 7 are completely submerged. In the present embodiment, as the electrolyte liquid 21, there is used a liquid containing nickel sulfamate as a main component.

FIG. 8 is referred to. In the producing jig 8, a plurality of thin wire materials 35 can be extended for producing a tube by electroforming having a plurality of hollow portions. It is to be noted that as the thin wire material 35 described in the present embodiment, the same material as that used in the electroforming device 100 is used, and therefore description thereof is omitted.

The producing jig 8 includes a plate-like jig main body 80 having a required length. Substantially in the center of the jig main body 80, an opening 81 extending through the body is formed. In FIG. 8, on opposite ends (short side) of the jig main body 80, which are upper and lower ends, a plurality of fixing members 82, 83 to fix the thin wire materials 35 are disposed at required intervals in a width direction (specifically, every eight places). In the present embodiment, as the fixing members 82, 83, screw-like members are used, but this is not especially limited.

Moreover, further inwardly from the fixing members 82, 83, intervals are further narrowed as compared with the intervals at which the fixing members 82, 83 are arranged, and a plurality of guide pins 84 are arranged (specifically, every eight places).

Furthermore, in the vicinity of the opening 81 which is an inner portion from the guide pins 84, there are arranged positioning members 85, 85 for positioning the thin wire materials 35 to be extended. Each of the positioning members 85, 85 is a band-like plate member having a length substantially equal to a width of the jig main body 80, and V-shaped grooves (not seen in the drawing because they are covered with a detachment preventing member 850 (described later)) into which the thin wire materials 35 are to be fitted are formed substantially in the center of the member. This groove ranges over the whole width (vertical direction in FIG. 8) of the positioning member 85, and a plurality of grooves (specifically in eight places) are arranged in a length direction (left to right direction in FIG. 8).

On the top of each positioning member 85, there is disposed the detachment preventing member 850 having a width substantially equal to that of the positioning member 85 but formed of a short plate-like member, and the fitted thin wire materials 35 are prevented from being detached from the grooves. In the present embodiment, the grooves of the positioning member 85 are formed so as to dispose a clearance of 10 μm between the thin wire materials 35 disposed adjacent to each other, but this is not restrictive, and the interval between the thin wire materials 35 can appropriately be set.

A plurality of (specifically, eight) thin wire materials 35 are attached to the producing jig 8. Each thin wire material 35 is attached as follows.

First, a tensile spring 86 is attached to the other end (lower side in FIG. 8) of the thin wire material 35. Moreover, one end (upper side in FIG. 8) of the thin wire material 35 is fixed with the fixing member 82. The thin wire material 35 fixed with the fixing member 82 is passed between the adjacent guide pins 84 and 84, fitted into the groove formed in each positioning member 85, and bridged between the positioning members 85 and 85.

The other end of the thin wire material 35 fitted into the groove is passed between the adjacent guide pins 84 and 84 in the same manner as in the upper end, and the tensile spring 86 is fixed with the fixing member 83. The thin wire material 35 is attached in a state in which tension is given to a portion of the thin wire material 35 corresponding to the opening 81 by the tensile force of the tensile spring 86.

It is to be noted that in the producing jig 8, the thin wire material 35 is attached with a clearance of 10 μm from the adjacent material, but the above interval is shown in FIG. 8 in an exaggerated manner in order to facilitate understanding.

Reference numeral 87 denotes a holding member to which partition wall members 88 are to be attached. The holding member 87 is formed of a rectangular plate-like member having a size which is substantially equal to that of an opening shape of the opening 81.

The partition wall member 88 has a length which is substantially equal to that of the holding member 87 in a vertical direction in FIG. 8, and has a band-like shape with a small thickness. To be more specific, the partition wall member 88 has a structure which includes an insulating base member 880 having a thickness of approximately 8 μm and in which conductive layers (films) 881 each formed by plating or the like and having a thickness of approximately 2 to 3 μm are disposed on front and back surfaces of the insulating base member 880. There is not any special restriction on a material forming the conductive layer 881 as long as the material has a conductivity. However, it is preferable that the material has a satisfactory close contact property (bonding property) with respect to the electrodeposit material formed by electroforming.

A plurality of (specifically, seven) partition wall members 88 are arranged at required intervals disposed so that the conductive layers 881 face the members, and detachably attached to substantially the center of the surface of the holding member 87 so as to extend along the whole length in the vertical direction of FIG. 8. In the present embodiment, since the above thin wire materials 35 are attached to the jig main body 80 with a clearance of approximately 10 μm formed therebetween, the partition wall members 88 are similarly attached with an interval of approximately 10 μm so that the interval corresponds to the clearance.

The holding member 87 provided with the partition wall members 88 is attached to the jig main body 80, when each partition wall member 88 is inserted from the side (arrow direction) between the thin wire materials 35 extended vertically along the opening 81, and the partition wall member 88 is held by the tensile force of the thin wire material 35. That is, the thin wire material 35 comes into contact with the partition wall member 88 (the conductive layer 881 in detail).

After the holding member 87 is attached to the jig main body 80 as described above, and the cathode wire 650 (not shown in FIG. 8) is connected so that electricity flows through the thin wire materials 35, the producing jig 8 is contained in the jig fixing frame member 7 of the tank portion 61, and submerged into the electrolyte liquid 21 to perform the electroforming. It is to be noted that specific description is omitted, but a place other than the opening 81 of the producing jig 8 is subject to a masking treatment so as to prevent the place from being submerged into the electrolyte liquid 21.

According to the electroforming device 101, energizing is performed to thereby form the electrodeposit material around the thin wire material 35 and on the surface of the conductive layer 881. Moreover, when the thin wire material 35 and the partition wall member 88 are surrounded with an electrodeposit material 55 to a required degree, the electroforming is stopped. An electrodeposit amount (deposit amount) of the electrodeposit material 55 can be controlled beforehand by a current, a voltage, an electroforming time or the like.

The producing jig 8 in which the electroforming is stopped is taken out of the electrolyte liquid 21, and disassembled again into the jig main body 80 and the holding member 87. At this time, since the partition wall member 88 is fixed by the deposited electrodeposit material 55 between the thin wire materials 35, the partition wall member is separated from the holding member 87. Thereafter, the thin wire material 35 and the partition wall member 88 integrated by the electrodeposit material 55 are detached from the jig main body 80.

Moreover, the electrodeposit material 55 and the partition wall member 88 are machined and shaped (see FIG. 9), and the thin wire material 35 is removed from the electrodeposit material 55. It is to be noted that the thin wire material 35 is removed by a method similar to a method of removing the material produced by the above electroforming device 100, and description thereof is therefore omitted.

In this manner, there is produced the tube by electroforming having a plurality of (specifically, eight) hollow portions.

In the tube by electroforming, since the partition wall member 88 is disposed between the hollow portions formed by removing the thin wire material 35 so as to partition the tube, each portion forming the periphery of each hollow portion can independently conduct electricity.

It is to be noted that even in the electroforming device 101, there may be used a thin wire material in which a core portion is made of a metal, a synthetic resin or the like and in which a conductive layer (plating (metal layer (film)), carbon or the like) is disposed on the outer surface of the core portion. Furthermore, there is not any special restriction on a sectional shape of the thin wire material or the like in the same manner as in the thin wire material shown in the electroforming device 101.

In the present embodiment, the partition wall member 88 is disposed between the thin wire materials 35 to perform the electroforming, but this is not restrictive, and it is possible to perform the electroforming in a state in which the only thin wire materials are disposed without disposing any partition wall member.

The tube by electroforming may be produced using an electroforming device other than the electroforming devices 100, 101 described above in the embodiments. There is not any special restriction on a type of the producing jig for use in the electroforming device.

A numeric value indicating a specific dimension (size, length) described in the present embodiment has been described in order to facilitate the understanding, and there is not any intension to especially restrict the dimension. Examples of the dimension include the diameter of the thin wire material, the thickness of the electrodeposit material, the deformation amount or the tensile force of the thin wire material, the thickness of the conductive layer (film) (plating or the like) and the thickness of the partition wall member. These dimensions can arbitrarily be set within a range, when the range is set.

In the present embodiment, it has been described that the metal is electrodeposited by the electroforming on the outer surface of the thin wire material to cover the thin wire material, but this is not restrictive, and a tube by electroforming may be produced by disposing an electric conductor (metal or the like) in the vicinity of the thin wire material, and electrodepositing the metal on this conductor by the electroforming, whereby the thin wire material is also covered with the electrodeposited metal.

In the above embodiment, as the electrolyte liquid, there is used a liquid containing nickel sulfamate as a main component, but the electrolyte liquid is not limited to this, and selected in accordance with a type of the metal to be deposited. Examples of the metal to be electrodeposited (deposited) include nickel or an alloy thereof, iron or an alloy thereof, copper or an alloy thereof, cobalt or an alloy thereof, a tungsten alloy and a metal such as a particle dispersed metal. As the electrolyte liquid to deposit the metal, there is used, for example: a liquid containing, as a main component, an aqueous solution of nickel chloride, nickel sulfate, ferrous iron sulfamate, fluoroboric ferrous iron, copper pyrophosphate, copper sulfate, fluoroboric copper, copper borofluoride, copper silicofluoride, copper titanium fluoride, copper alkanolsulfamate, cobalt sulfate, sodium tungstate or the like; or a liquid obtained by dispersing, in the above liquid, fine powder of silicon carbide, tungsten carbide, boron carbide, zirconium oxide, silicon titanate, alumina, diamond or the like,

Moreover, in the electroforming tank, stirring means for stirring the electrolyte liquid can be disposed. As the stirring means, there is usable, for example: air blowing means; means for sucking the electrolyte liquid and again discharging the liquid into an electrolyte tank; a rotatable stirring blade (propeller); an ultrasonic waves; vibration or the like. However, the stirring means is not limited to them.

The terms and representations used in the present description are absolutely used for description, and are not restrictive, and there is not any intention to exclude the terms or the representations equivalent to the characteristics described in the present description and a part of the characteristics. Needless to say, various modifications are possible in the scope of the technical idea of the present invention.

### INDUSTRIAL APPLICABILITY

The present invention includes the above constitution, and has the following effects.

(a) According to the present invention, a thin wire material can be removed from an electrodeposit material or a surrounding material formed by electroforming. The thin wire material is removed using any of methods of: (1) heating and thermally expanding the electrodeposit material or the surrounding material, or cooling and contracting the thin wire material to thereby form a clearance between the electrodeposit material or the surrounding material and the thin wire material; (2) submerging the material into a liquid or applying the liquid to the material, whereby a place with which the thin wire material and the electrodeposit material or the surrounding material are brought into contact is formed so as to easily slip; or (3) pulling the material from one end or both ends, deforming the material so as to reduce a sectional area thereof, and forming the clearance between the thin wire material and the electrodeposit material or the surrounding material, followed by gripping and pulling the material, sucking the material, physically pushing away the material, or blowing a gas or a liquid to push away the material. The material can also be removed by (4) melting the material with heat or a solvent.

When such method is used in removing the thin wire material, and, for example, a thin wire material having a diameter of 10 μm to 85 μm is used, the thin wire material can be removed even from the electrodeposit material or the surrounding material formed on the outer surface of this thin wire material so as to have a thickness of 5 μm or more and 50 μm or less. Therefore, when this thin wire material removing method is used, it is possible to produce, for example, a tube by electroforming usable as a tube for a contact probe or the like and having a fine inner diameter.

(b) According to a method of increasing an amount of an end-portion-side electrodeposit or surrounding material to be formed on the thin wire material to produce the tube by electroforming, for example, in a case where the thin wire material is extracted or pushed away and removed from the electrodeposit material or the surrounding material, a jig, a tool or the like can be caught by an end surface of the portion in which the amount of the electrodeposit material or the surrounding material is increased. Therefore, in this case, the thin wire material can be removed in a state in which the electrodeposit material or the surrounding material is fixed, and therefore the thin wire material is easily removed.

(c) According to a tube electroforming method in which a deformation amount of a lateral distortion is set to 5% or more of the sectional area at a time when the thin wire material is pulled and extended outwards, since a clearance sufficient for removing the thin wire material can be formed between the thin wire material and the electrodeposit material or the surrounding material, there is a high possibility that the thin wire material can be removed from the electrodeposit material or the surrounding material without any trouble. If the deformation amount of the lateral distortion is only less than 5% of the sectional area, the clearance is not sufficient. Therefore, the trouble sometimes occurs during the removing.

(d) According to a tube electroforming method in which the thin wire material having a conductive layer disposed on the outer surface thereof is used, and the thin wire material is removed so that the conductive layer remains on the inner surface of the tube by electroforming, it is possible to produce the tube by electroforming having gold plating or the like disposed on the inner surface thereof. In accordance with, for example, a material of the conductive layer disposed on the inner surface of the tube, such tube by electroforming can have an electric conductivity which is more satisfactory than that of a case where the electrodeposit material or the surrounding material only is disposed. Therefore, in this case, the tube is usable as a component suitable for conducting electricity.

It is to be noted that even as to the tube by electroforming having the inner surface provided with a conductive layer constituted of a material different from that of the electrodeposit material or the surrounding material, or the thin wire material having the outer surface provided with the conductive layer constituted of the material different from that of the electrodeposit material or the surrounding material, it is similarly possible to form the tube by electroforming having an electric conductivity which is more satisfactory than that of the case where the electrodeposit material or the surrounding material only is disposed.

(e) According to a tube electroforming method in which there is used a thin wire material having the outer surface provided with at least two or more conductive layers constituted of different materials, for example, the outer conductive layer is made of copper, the inner conductive layer brought into contact with copper is made of gold, and nickel is formed as the electrodeposit material or the surrounding material by the electroforming. In this case, nickel has a satisfactory close contact property with respect to copper rather than gold, copper also has a satisfactory close contact property with respect to gold, and it is therefore possible to produce the tube by electroforming having a satisfactory close contact property.

It is to be noted that as to a tube by electroforming in which the conductive layer constituted of the material different from that of the electrodeposit material or the surrounding material is disposed on the inner surface of the tube and in which a further conductive layer constituted of the material different from that of the conductive layer is disposed between the electrodeposit material or the surrounding material and the above conductive layer, or as to a thin wire material in which the conductive layer constituted of the material different from that of the electrodeposit material or the surrounding material is disposed on the outer surface of the material and in which the further conductive layer constituted of the material different from that of the conductive layer is disposed between a thin wire material base member and the above conductive layer, it is similarly possible to form the tube by electroforming having the satisfactory close contact property between the electrodeposit material or the surrounding material and the conductive layer.

(f) A component including a plurality of hollow portions formed by removing the thin wire material may replace, for example, a component produced by arranging a plurality of tubes each having only one hollow portion, and may be used. According to the tube by electroforming, it is possible to eliminate an operation of arranging the individual tubes. An interval between the hollow portions does not deviate because the portions are fixed with the electrodeposit material or the surrounding material.

(g) In a case where a partition wall member formed by disposing the conductive layer on the outer surface of an insulator is disposed between the hollow portions, and each portion forming the periphery of each hollow portion can independently conduct electricity, each hollow portion can independently conduct electricity.

(h) As to a thin wire material having, on opposite ends, portions on which any conductive layer is not disposed, in a case where the portion on which any conductive layer is not disposed is pulled outwards, a tensile force is not directly or easily applied to the conductive layer, the conductive layer is easily separated from a base wire material, and the close contact property between the conductive layer and the electrodeposit material or the surrounding material is not easily impaired.

1. (canceled)

2. (canceled)

3. A tube electroforming method comprising the steps of: forming an electrodeposit material or a surrounding material around a thin wire material by electroforming; and removing the thin wire material from the electrodeposit material or the surrounding material,
wherein the thin wire material is removed by pulling the material from one end or both ends, deforming the material so as to reduce a sectional area thereof, and forming a clearance between the thin wire material and the electrodeposit material or the surrounding material, followed by gripping and pulling the thin wire material, sucking the material, physically pushing away the material, or blowing a gas or a liquid to push away the material.

4. The tube electroforming method according to claim 3,
wherein an amount of an end-portion-side electrodeposit or surrounding material to be formed on the thin wire material is increased.

5. The tube electroforming method according to claim 3,
wherein a deformation amount of a lateral distortion at a time when the thin wire material is pulled and extended outwards is 5% or more of the sectional area.

6. (canceled)

7. The tube electroforming method according to claim 3,
wherein the thin wire material including a conductive layer disposed on an outer surface thereof is used, and the thin wire material is removed so that the conductive layer remains on an inner surface of a tube by electroforming.

8. The tube electroforming method according to claim 3,
wherein the thin wire material is used in which at least two conductive layers constituted of different materials are formed on an outer surface of the material, the electrodeposit material or the surrounding material is brought into close contact with the outer conductive layer of the thin wire material, and the thin wire material is removed so that the inner conductive layer remains on an inner surface of the tube by electroforming.

9. The tube electroforming method according to claim 3,
wherein an inner shape of a hollow portion formed by removing the thin wire material from the electrodeposit material or the surrounding material has a circular sectional shape or a polygonal sectional shape.

10. The tube electroforming method according to claim 3,
wherein the tube by electroforming includes a plurality of hollow portions formed by removing the thin wire material.

11. The tube electroforming method according to claim 10,
wherein a partition wall member formed by disposing a conductive layer on an outer surface of an insulating material is disposed between the hollow portions, whereby each portion forming a periphery of each hollow portion independently conducts electricity.

12. A tube by electroforming produced by forming an electrodeposit material or a surrounding material around a thin wire material by electroforming, and removing the thin wire material from the electrodeposit material or the surrounding material,
wherein a hollow portion is formed by removing the thin wire material from the electrodeposit material or the surrounding material, an inner diameter of the hollow portion is 10 μm or more and 85 μm or less, when an inner shape of the hollow portion has a circular sectional shape, a diameter of an inscribed circle of the hollow portion is 10 μm or more and 85 μm or less, when the inner shape of the hollow portion has a polygonal sectional shape,
there are a plurality of hollow portions formed by removing the thin wire material, and
a partition wall member formed by disposing a conductive layer on an outer surface of an insulating material is disposed between the hollow portions, whereby each portion forming a periphery of each hollow portion independently conducts electricity.

13. The tube by electroforming according to claim 12, having a thickness of 5 μm or more and 50 μm or less.

14. The tube by electroforming according to claim 12, having an inner surface provided with a conductive layer constituted of a material different from that of the electrodeposit material or the surrounding material.

15. The tube by electroforming according to claim 12, having an inner surface of the tube provided with a conductive layer constituted of a material different from that of the electrodeposit material or the surrounding material, a further conductive layer constituted of a material different from that of the conductive layer being disposed between the electrodeposit material or the surrounding material and the conductive layer.

16. (canceled)

17. (canceled)

18. The tube by electroforming according to claim 12, wherein the conductive layer disposed on the outer surface of the partition wall member is constituted to form a part of the hollow portion.

19. The tube by electroforming according to claim 12, wherein a portion of the partition wall member disposed between the hollow portions disposed adjacent to each other has a thickness of 5 μm or more and 50 μm or less.

20. A thin wire material for production of a tube by electroforming produced by forming an electrodeposit material or a surrounding material around the thin wire material by electroforming, and removing the thin wire material from the electrodeposit material or the surrounding material,
wherein an outer diameter of the thin wire material is 10 μm or more and 85 μm or less, when an outer shape of the thin wire material has a circular sectional shape, a diameter of an inscribed circle is 10 μm or more and 85 μm or less, when the outer shape of the thin wire material has a polygonal sectional shape, and a deformation amount of a lateral distortion at a time when the thin wire material is pulled and extended outwards is 5% or more of a sectional area.

21. (canceled)

22. (canceled)

23. (canceled)

24. (canceled)

25. A thin wire material for production of a tube by electroforming produced by forming an electrodeposit material or a surrounding material around the thin wire material by electroforming, pulling the thin wire material from one end or both ends to deform the material so that a sectional area thereof is reduced, forming a clearance between the thin wire material and the electrodeposit material or the surrounding material to extract the thin wire material, and removing the thin wire material from the electrodeposit material or the surrounding material to produce a tube by electroforming,
wherein an outer diameter of the thin wire material is 10 m or more and 85 μm or less, when an outer shape of the thin wire material has a circular sectional shape, a diameter of an inscribed circle is 10 μm or more and 85 μm or less, when the outer shape of the thin wire material has a polygonal sectional shape, and a deformation amount of a lateral distortion at a time when the thin wire material is pulled and extended outwards is 5% or more of the sectional area.

26. The thin wire material for the production of the tube by electroforming according to claim 20, having an outer surface provided with a conductive layer constituted of a material different from that of the electrodeposit material or the surrounding material.

27. The thin wire material for the production of the tube by electroforming according to claim 20, having an outer surface of the material provided with a conductive layer constituted of a material different from that of the electrodeposit material or the surrounding material, a further conductive layer constituted of a material different from that of the conductive layer being disposed between a base member of the thin wire material and the conductive layer.

28. The thin wire material for the production of the tube by electroforming according to claim 20, wherein there are opposite end portions on which any conductive layer is not disposed.

29. The thin wire material for the production of the tube by electroforming according to claim 20, having an outer shape formed into a circular sectional shape or a polygonal sectional shape.

30. A tube by electroforming produced by forming an electrodeposit material or a surrounding material around the thin wire material by electroforming, and removing the thin wire material from the electrodeposit material or the surrounding material,
wherein a hollow portion is formed by removing the thin wire material from the electrodeposit material or the surrounding material, an inner diameter of the hollow portion is 10 μm or more and 85 μm or less, when an inner shape of the hollow portion has a circular sectional shape, and a diameter of an inscribed circle of the hollow portion is 10 μm or more and 85 μm or less, when the inner shape of the hollow portion has a polygonal sectional shape.

31. A tube by electroforming produced by forming an electrodeposit material or a surrounding material around the thin wire material by electroforming, pulling the thin wire material from one end or both ends to deform the material so that a sectional area thereof is reduced, forming a clearance between the thin wire material and the electrodeposit material or the surrounding material to extract the thin wire material, and removing the thin wire material from the electrodeposit material or the surrounding material,
wherein a hollow portion is formed by removing the thin wire material from the electrodeposit material or the surrounding material, an inner diameter of the hollow portion is 10 μm or more and 85 μm or less, when an inner shape of the hollow portion has a circular sectional shape, and a diameter of an inscribed circle of the hollow portion is 10 μm or more and 85 μm or less, when the inner shape of the hollow portion has a polygonal sectional shape.

32. The tube by electroforming according to claim 30, having a thickness of 5 μm or more and 50 μm or less.

33. The tube by electroforming according to claim 30, having an inner surface provided with a conductive layer constituted of a material different from that of the electrodeposit material or the surrounding material.

34. The tube by electroforming according to claim 30, having an inner surface provided with a conductive layer constituted of a material different from that of the electrodeposit material or the surrounding material, a further conductive layer constituted of a material different from that of the conductive layer being disposed between the electrodeposit material or the surrounding material and the conductive layer.

35. The tube by electroforming according to claim 31, wherein there are a plurality of hollow portions formed by removing the thin wire material.
